(19) United States
(12) Patent Application Publication
(10) Pub. No.: US 2015/0237865 A1
(43) Pub. Date: Aug. 27, 2015

(54) METHOD TO CONTROL SPREAD OF NOXIOUS WEED

(71) Applicants: André Grégoire, Terrebonne (CA); Alain Meilleur, Montreal (CA)

(72) Inventors: André Grégoire, Terrebonne (CA); Alain Meilleur, Montreal (CA)

(21) Appl. No.: 14/238,716

(22) PCT Filed: Aug. 13, 2012
(86) PCT No.: PCT/CA2012/050547

§ 371 Date: Mar. 30, 2015

Related U.S. Application Data
(60) Provisional application No. 61/522,989, filed on Aug. 12, 2011.

(51) Int. Cl. A01N 59/08; A01N 25/02

(52) U.S. Cl. CPC A01N 59/08; A01N 25/02

(57) ABSTRACT

The present invention relates to a method of controlling spread of a noxious weed comprising the step of injecting a non-toxic solution in the ground proximate to the noxious weed plant.

### CROSS-REFERENCE TO RELATED APPLICATIONS

The present application claims benefit of U.S. Provisional Application No. 61/522,989, filed Aug. 12, 2011, which is hereby incorporated herein by reference in its entirety.

### TECHNICAL FIELD

The present invention relates to a method of controlling spread of a noxious weed comprising the step of injecting a non-toxic solution in the ground proximate to the noxious weed.

### BACKGROUND ART

Proliferation of noxious weeds is one of the most important factor contributing to the lost of biodiversity. Two examples of prevalent and noxious weeds are the Japanese knotweed (Fallopia japonica) and the Giant knotweed (Fallopia sachalinensis). Both of these species are originating from Asia (China, Japan, Korea and Taiwan) and are now spreading in the United-States, Canada, New-Zealand and Europe.

The Japanese knotweed is a frequent colonizer of temperate riparian ecosystems, roadsides and waste places. It is listed by the World Conservation Union as one of the world's 100 worst invasive species. Japanese knotweed, a member of the buckwheat family (Polygonacaea) is an upright, herbaceous, shrub-like perennial that often grows to heights in excess of ten feet. As with all members of this family, the base of the stem above each joint is surrounded by a membranous sheath and stems are smooth (bamboo-like) and swollen at the joints where the leaf joins the stem. Leaf sizes are normally about six inches long, and three to four inches wide, oval to somewhat triangular. Plants grow quickly and often form large thickets or patches. The roots are rhizomes that can survive temperatures of −35° C. and can extend 7 metres horizontally and 3 metres deep, making removal by excavation extremely difficult. A very small fraction of the rhizomes (about 1 cm long) is sufficient to regenerate a viable plant and buds along the length of rhizomes may develop into new stems depending upon environmental and cultural conditions. Digging around the base of established plants encourages new vegetative buds to develop along the rhizome system. The plant is also resilient to cutting, vigorously re-sprouting from the roots.

The Giant knotweed is an herbaceous perennial plant growing to 2-4 m tall, with strong, extensively spreading rhizomes forming large clonal colonies. The leaves are 15-40 cm long and 10-28 cm broad, nearly heart-shaped. The flowers are small, produced on short, dense panicles up to 12 cm long. It is closely related to Fallopia japonica, and can be distinguished from it by its larger size, and in its leaves having a heart-shaped (not straight) base and a crenate margin.

Both of these knotweed species forms thick, dense colonies that completely crowd out any other herbaceous species and are now considered one of the worst invasive plants. The success of theses species has been partially attributed to their tolerance of a very wide range of soil types, pH and salinity, and also to their ability to secrete allelopathic toxins which reduce the regeneration of native plants.

Known methods of knotweed control include foliar application of a solution containing 2% glyphosphate which penetrates through the whole plant and travels to the roots. Foliar applications involve applying small droplets over the entire plant (stems and leaves). On established root wads, the spraying of new growth may take several applications over several years to achieve control. Depending upon size of infestation, foliar applications may require re-treatment during the growing season and possible follow-up treatment in successive years.

Another known knotweed control method is the use of cut stem applications. Cut stem applications are made by cutting the knotweed stem between the first and second internode, and delivering an herbicide, such as a solution comprising 25% of glyphosphate, into the “well” created by cutting the internode in half. Cut stem applications have proven to be effective on mature plants.

Stem injection is also used to control knotweed proliferation. Stem injection applications are those applications made just below the first or second node about and above the ground. Typically, a probe is used to create a small opening on either side of the stem just below the node. This allows water to escape while the syringe metered to inject an herbicide treatment, delivers the treatment dose on a downward diagonal through one of the two holes closest to the applicator.

U.S. Pat. No. 7,165,357 discloses an apparatus for injecting a dose of weed-killing fluid into the stem of the knotweed which involves impaling both sides of the knotweed stem with a needle.

U.S. Pat. No. 5,330,964 discloses a method of controlling low lying vegetation by providing and applying sodium bicarbonate on the vegetation so that the bicarbonate accumulate and forms a layer between ⅛ to ¼ inch of thickness.

There is still a need to be provided with a method for controlling knotweed proliferation by applying a non-toxic solution for selective control of noxious weeds.

### SUMMARY

In accordance with the present invention there is now provided a method of controlling spread of noxious weed comprising the step of injecting a non-toxic solution in the grounds proximate to the noxious weed.

In accordance to another embodiment, it is provided an injectable non-toxic solution for controlling spread of a noxious weed plant, the injectable non-toxic solution eliminating the rhizomes or the taproot of the noxious weed plant.

In an embodiment, the injection is a pressure injection in the grounds proximate to the noxious weed.

Particularly, the non-toxic solution can be injected at a pressure between 20 psi and 350 psi.

In another embodiment, the non-toxic solution is injected to a deepness of at least 30 cm, or to a deepness of at least 50 cm.

In an embodiment, 100 ml to 5 l, preferably 100 ml to 5 l of the non-toxic solution is injected.

The non-toxic solution encompassed herein can be a saline solution. The saline solution can comprise a salt selected from the group consisting of aluminum chloride, ammonium phosphate monobasic, calcium chloride dihydrate, calcium chloride hexahydrate, calcium chloride anhydrous, calcium hypochlorite, calcium nitrate tetrahydrate, decansulphonic sodium acid salt, ethylene diamine tetraacetic acid disodium (EDTA); ethylene diamine tetraacetic acid tetrasodium (EDTA), ferric chloride hexahydrate, ferric chloride, ferric nitrate nonahydrate, ferrous chloride tetrahydrate, hepes sodium salt, iodine chloride, lithium chloride, magnesium chloride hexahydrate, magnesium nitrate, manganese chloride, 1-pentanesulphonic acid sodium salt, potassium chloride, potassium nitrate, potassium nitrite, sodium acetate anhydrous; sodium acetate trihydrate, sodium azide, sodium β-glycerophosphate, sodium benzoate, sodium bicarbonate, sodium bisulphite, sodium borate decahydrate, sodium borohydride, sodium bromide, sodium carbonate anhydrous, sodium carbonate decahydrous, sodium carbonate monohydrous, sodium chloride, sodium chlorite, sodium iodide, sodium nitrate, sodium nitrite, sodium silicate, sodium sulfate, sodium sulfite, sodium tripolyphosphate, sorbic acid, zinc chloride, and zinc nitrate hexahydrate.

Preferably, the salt is NaCl.

In an additional embodiment, the non-toxic solution is a saline solution consisting of 0.01% to 36% weight to volume of NaCl, of 8% to 14% weight to volume of NaCl, particularly of 12% weight to volume of NaCl.

In a particular embodiment, the non-toxic solution is Adios Ambros®.

It is encompassed that the saline solution may comprise at least one adjuvant. The adjuvant can be selected from the group consisting of nonionic or cationic surfactants, mineral oils, mineral oil surfactants, vegetable oils, spreader sticker, wetting agent and ammonium sulfate.

The adjuvant can be selected from the group consisting of ACCUTROL™ spray adjuvant, ACTIPRON, AGRAL™ 90, AG-SURF, AL 821, AL 826, AL 1399, ammonium sulfate, ALIPAL™ CO, AMIGO™, ASSIST™ oil concentrate, ATPLUS™ 411 F, ATPLUS 449, ATPLUS™ 555, AMWAY™ spray adjuvant, ATRAOIL™ concentrate, BCI 007, BESTLINE, BIO-FILM™, BIO-VEG™, BIVERT™ HCE, BIVERT™ PH, BIVERT™ TDN, Bob Chambers surfactant wetting agent, CANPLUS™ 411, CD 351, CD 352, CD 353A, CHARGE™ mineral oil surfactant, CHEMPAR M, CHIPMAN corn oil concentrate, CITOWETT™ PLUS, COMPANION™, CONTROL™ OIL, CO-OP™ SURFACTANT, CO-OP™ emulsifiable spray oil, ENHANCE™ ESSOBAYOL 90, ETKOHEM, EV crop oil, FAIRMOUNT SURFACTANT wetting agent, FRIGATE™, GENAPOL™ X-060, GENAPOL™ X-080, GENOMOLL™ 100, GREEN CROSS™ adjuvant T, GREEN CROSS™ booster plus, IN 291, IN 292, IPCO™ oil concentrate, KANCEL™ spray additive liquid, KOMBAT™ NO. 1, KORN oil, KORN oil concentrate, LATER'S SURFACTANT, LO-DRIFT™, low foam additive, MARASPERSE N-22, MERGE™, MULTIFILM, NACCONOL™ 88SA, NALCOTROL™, POLYFON™ O, R 25788, R 33865, RAPE oil, REGULAID, RENEX™ 36, SIDE KICK, SIPON™ ES, SPRAYCO premium mineral oil, SPAYCO oil concentrate, soybean oil, sorbitol, SUPERIOR oil concentrate, SUPER SPREADER STICKER, SURF™ 92, SURFACTANT wk, Surfel, SYLGARD™ 309, TRITON™ AF adjuvant foamer, TRITON™ B1956 spreader sticker, TRITON™ CS 7 spreader sticker, TRITON™ X-100, TRITON™ X-114, TRITON™ XA special spray adjuvant, TRITON™ XA spray adjuvant, TRITON™ XR, TURBOCHARGE™, TWEEN™ 20, TWEEN™ 40, TWEEN™ 60, TWEEN™ 80, vegetable oil, and XA oil.

In an embodiment, the vegetable oil is selected from the group consisting of corn, soybean, flax and cottonweed.

In another embodiment, the saline solution comprises 0.25% to 1% weight to volume of the adjuvant.

In an additional embodiment, the noxious weed plant is a knotweed, a dandelion, a burdock, a buckthorn, a giant hogweed, a poison ivy, a bittersweet, a mugwort, an european swallow-wort or a cow parsley.

Particularly, the knotweed is a Japanese knotweed or a Giant knotweed.

In an embodiment, injecting the non-toxic solution in the ground eliminates the rhizomes or the taproot of the noxious weed plant.

### BRIEF DESCRIPTION OF THE DRAWINGS

Reference will now be made to the accompanying drawings, showing by way of illustration:

FIG. 1 illustrates a histogram demonstrating the efficacy of the methodology described herein to reduce the number of Japanese knotweed in 5 testing sites.

FIG. 2 illustrates a histogram showing the reduction of the number of stem after treatment in 5 testing sites.

FIG. 3 illustrates a histogram showing the specificity of the treatment by measuring the height of adjacent untreated stem to injection site, before and after treatment.

FIG. 4 illustrates a histogram showing the specificity of the treatment by measuring the height, the number of leaves, and number of branches of adjacent untreated stem to injection site, before and after two treatments and one year after the first treatment.

FIG. 5 illustrates a histogram showing the specificity of the 3 different treatments (cutting, spraying and injection) by measuring the height, the number of leaves, and number of branches of adjacent untreated stem to injection site, before and after treatment.

FIG. 6 illustrates a histogram showing the specificity of the treatment by measuring the height and the number of stems of adjacent untreated stem to injection site, before and after treatment.

FIG. 7 illustrates a photographic representation of the efficacy of the treatment at one month (B) post treatment compared to untreated Japanese knotweed (A).

FIG. 8 illustrates a photographic representation of the efficacy of the treatment at 1 day (B) and 1 week (C) post treatment compared to untreated Giant hogweed (A).

### DETAILED DESCRIPTION

It is provided a method of controlling proliferation of noxious weeds comprising injecting a non-toxic solution in the grounds proximate to the noxious weeds to eliminate roots and/or rhizomes of the weeds.

The method described herein consist in injecting a non-toxic solution specific for noxious weed in the grounds in order to insure that the rhizomes and taproot are eliminated and do not regenerate.

A taproot of a plant is an enlarged, somewhat straight to tapering plant root that grows downward. It forms a center from which other roots sprout laterally. The presence of a taproot is why dandelions are hard to uproot. When the top is pulled, the long taproot stays in the ground and resprouts.

Preferably, the non-toxic solution can be injected to a deepness of up to 50 cm, preferably to 30 cm. The deepness of the injection might vary between specific species of noxious weeds that need to be eradicated since the roots and/or rhizomes system deepness might vary between species.

One of the problems of trying to control the spread of noxious weeds such as knotweeds is that the base of established plants encourages new vegetative buds to develop along the rhizomes system. Some noxious weed plants are more difficult to eliminate when an herbicide is sprayed for example because the rhizomes system is not affected and they can regenerate the plants subsequently.

The methodology described herein was conceived after the observation that in a 2 to 3 centimeters circumference around Japanese knotweed stems, rhizomes of a large diameter are present. Even more, rhizomes are present to a deepness of 30 to 50 cm. Consequently, the methodology developed and described herein eradicates the rhizomes system which allows the Japanese knotweed to survive and promote spreading of the species after treatment with known techniques.

The methodology described herein is used for inhibiting the growth of a noxious weed plant having a root system or rhizomes system in the ground. Targeted noxious weed are for example but not limited to, knotweed, dandelion, burdock, buckthorn, giant hogweed, european swallow-wort or cow parsley.

Any non-toxic solution can be used with the methodology described herein. Preferably, the saline solution described in U.S. Pat. No. 6,372,690 is used, the content of which is herein incorporated by reference. Also preferred, the non-toxic solution is Adios Ambrose commercialized by the company Herbanatur.

A non-toxic solution is intended to mean a solution without effect to the environment and organisms in contact with the application or injection sites. The non-toxic solution needs to have substantially no effect on native plants such as grass surrounding the undesirable noxious weeds.

The concentration of solution being injected will vary on the specie targeted and the surrounding environment. A low concentration of salt beyond can result in an inefficient solution depending on the targeted noxious weed. A high concentration of salt in the solution can result in a non-selective composition and kill grass or plants surrounding the targeted noxious weed, Consequently, a foliar saline solution comprising from 0.01% to 36% (saturation) weight to volume (W/V) of salt in an aqueous solution, more preferably 8% to 12%, and most preferably 12% can be used.

The salt comprised in the solution can be selected from the group consisting of aluminum chloride; ammonium phosphate monobasic, calcium chloride dihydrate, calcium chloride hexahydrate, calcium chloride anhydrous, calcium hypochlorite, calcium nitrate tetrahydrate, decansulphonic sodium acid salt, ethylene diamine tetraacetic acid disodium (EDTA); ethylene diamine tetraacetic acid tetrasodium (EDTA), ferric chloride hexahydrate, ferric chloride, ferric nitrate nonahydrate, ferrous chloride tetrahydrate, hepes sodium salt, iodine chloride, lithium chloride, magnesium chloride hexahydrate, magnesium nitrate, manganese chloride, 1-pentanesulphonic acid sodium salt, potassium chloride, potassium nitrate, potassium nitrite, sodium acetate anhydrous; sodium acetate trihydrate, sodium azide, sodium β-glycerophosphate, sodium benzoate, sodium bicarbonate, sodium bisulphite, sodium borate decahydrate, sodium borohydride, sodium bromide, sodium carbonate anhydrous, sodium carbonate decahydrous, sodium carbonate monohydrous, sodium chloride, sodium chlorite, sodium iodide, sodium nitrate, sodium nitrite, sodium silicate, sodium sulfate, sodium sulfite, sodium tripolyphosphate, sorbic acid, zinc chloride and zinc nitrate hexahydrate.

Since some salts may have a lower solubility, the solution in accordance with an embodiment may comprise a solubilizing agent.

In accordance with one embodiment, the solution may further comprise at least one adjuvant. Such adjuvant can be selected from the group consisting of ACCUTROL™ spray adjuvant, ACTIPRON, AGRAL™ 90 (non-ionic surfactant), AG-SURF (non-ionic surfactant), AL 821, AL 826, AL 1399, ammonium sulfate, ALIPAL™ CO (Series non-ionic surfactants), AMIGO™ (surfactant), ASSIST™ oil concentrate (mineral oil surfactant), ATPLUS™ 411 F, ATPLUS™ 449, ATPLUS™ 555, AMWAY™ spray adjuvant, ATRAOIL™ concentrate, BCI 007, BESTLINE, BIO-FILM™, BIO-VEG™, BIVERT™ HCE, BIVERT™ PH, BIVERT™ TDN, Bob Chambers surfactant wetting agent, CANPLUS™ 411 (mineral oil surfactant), CD 351, CD 352, CD 353A, CHARGE™ mineral oil surfactant, CHEMPAR M, CHIPMAN corn oil concentrate, CITOWETT™ PLUS (nonionic surfactant), COMPANION™ (non-ionic surfactant), CONTROL™ OIL, CO-OP™ SURFACTANT, CO-OP™ emulsifiable spray oil (mineral oil), ENHANCE™ (cationic and non-ionic surfactant), ESSOBAYOL 90, ETKOHEM, EV crop oil, FAIRMOUNT SURFACTANT wetting agent, FRIGATE™ (cationic surfactant), GENAPOL™ X-060, GENAPOL™ X-080, GENOMOLL™ 100, GREEN CROSS™ adjuvant T, GREEN CROSS™ booster plus, IN 291, IN 292, IPCO™ oil concentrate (mineral oil), KANCEL™ spray additive liquid, KOMBAT™ NO. 1, KORN oil (mineral oil), KORN oil concentrate (mineral oil surfactant), LATER'S SURFACTANT, LO-DRIFT™, low foam additive, MARASPERSE N-22 (non-ionic surfactants), MERGE™ (surfactant), MULTIFILM, NACCONOL™ 88SA (non-ionic surfactant), NALCOTROL™, POLYFON™ O (non-ionic surfactant), R 25788, R 33865, RAPE oil, REGULAID, RENEX™ 36, SIDE KICK, SIPON™ ES (non-ionic surfactant), SPRAYCO premium mineral oil (mineral oil), SPAYCO oil concentrate (mineral oil/surfactant), soybean oil, sorbitol, SUPERIOR oil concentrate (mineral oil/surfactant), SUPER SPREADER STICKER (nonionic surfactant spreader sticker), SURF™ 92 (non-ionic surfactant), SURFACTANT wk, Surfel, SYLGARD™ 309 (non-ionic surfactant), TRITON™ AF adjuvant foamer, TRITON™ B1956 spreader sticker, TRITON™ CS 7 spreader sticker, TRITON™ X-100 (non-ionic surfactant), TRITON™ X-114, TRITON™ XA special spray adjuvant (non-ionic surfactant), TRITON™ XA spray adjuvant, TRITON™ XR, TURBOCHARGE™ (mineral oil), TWEEN™ 20 (non-ionic surfactants), TWEEN™ 40, TWEEN™ 60, TWEEN™ 80, vegetable oils (such as corn, soybean, flax, or cottonweed) (spreaders and stickers), and XA oil (mineral oil surfactant). Preferably the adjuvant is CITOWETT™ PLUS or AGRAL™ 90. The adjuvant, when added to the solution, is preferably present in concentration of 0.25% to 1% weight to volume.

The optimal concentration of salt in solution and the conditions of injection in the ground of the solution may vary for plants from one species to another. Some plants from one species will react differently to a treatment with the salt solution than others. The reaction to the treatment with the solution can thus be different from one species to another and be adjusted without undue experimentation.

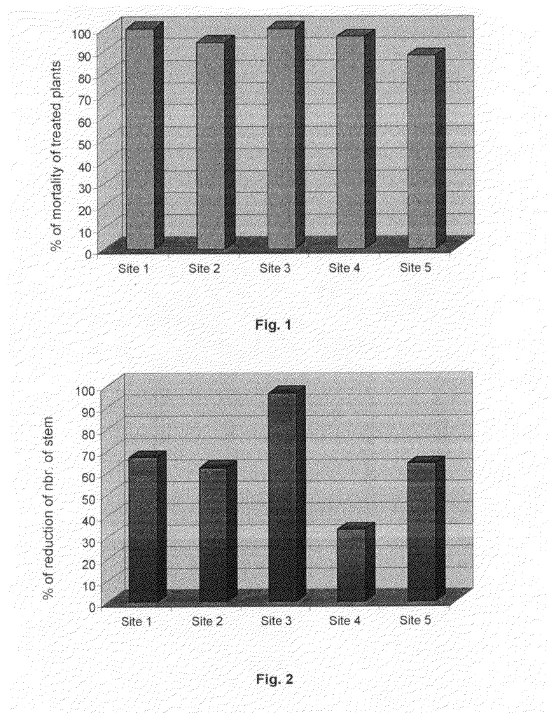

Pressure injection of a saline solution in various testing sites showed a mortality rate of 87.8% to 100% of targeted Japanese knot plants (see FIG. 1), and no regeneration was observed 11 months following the treatment. Visually, it is possible to see the efficacy of the treatment on Japanese knot plants as quickly as 1 day after treatment, more visible 1 week after treatment, making the present methodology an accessible and attractive process to treat noxious weeds proliferation for home consumer where single injection are preferred. The home consumer desires a method for controlling proliferation of noxious weeds where quick results can be measured visually, as it is the case with the methodology describe herein.

The saline solution can be injected with a pressure between 20 psi to 350 psi. Less pressure is used to inject the solution when the targeted noxious weed has a root system or rhizomes which are near the surface of the ground. The pressure of injection can be increased depending on specific species of noxious weeds that need to be eradicated since the roots and/or rhizomes system deepness might vary between species.

The volume of the solution to be injected can also vary between 100 ml to 5 l, depending on the nature of the root system or rhizomes of the noxious weed. Less volume (for example between 100 ml to 3.5 l) is needed to be injected for weeds having a root system or rhizomes which are near the surface of the ground. More volume is needed to be injected when root system goes deep in the ground.

The present disclosure will be more readily understood by referring to the following examples which are given to illustrate embodiments rather than to limit its scope.

### Example I

### Treatment of Japanese Knotweeds by Injecting a Saline Solution in the Ground

An experimental protocol was conceived to measure the efficacy of a saline injection in the ground proximal to a Japanese knotweed plant to eliminate rhizomes of the plant. Testing sites were selected in two different locations in Montréal, Canada. 3 m by 3 m testing sites were delimited.

In the delimited sites, height and width of Japanese knotweed stems were measured.

Metallic stalk markers were inserted in the ground proximal to the targeted plants before testing so that results could be analyzed qualitatively and quantitatively.

A saline solution of 12% NaCl was injected to a deepness of 30 cm proximal to the stem of the Japanese knotweeds identified by the markers. Efficacy of the injection was observed and measured (variation in stem survival and growth) compared with measurement and observation noted before treatments.

Testing was done in July of 2009 and results demonstrate that almost all treated Japanese knotweed stems were eliminated. Precisely, mortality rate of 87.8% to 100% were observed from all testing sites (see FIG. 1).

In June of 2010, 11 months post treatment, treated plants did not grow or regenerate and regeneration of rhizomes was not observed.

Impact of the saline solution injection was observed in a 30 cm diameter surrounding the point of injection. As illustrated in FIG. 2, the number of untreated stems surrounding the point of injection was also reduced, confirming the potency of the treatment not only to eradicate targeted Japanese knotweed plants but also to control spreading of untargeted Japanese knotweed surrounding the point of injection. Adjacent stems in contact by their rhizomes system to targeted plants were also eliminated by the injection of the saline solution in the ground.

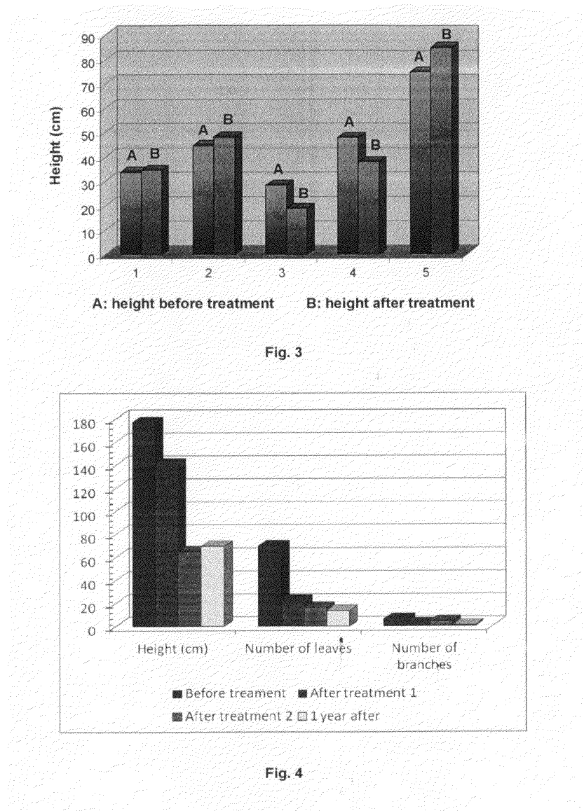

It was also noted that surviving plants in a testing site following injections of the saline solution in the ground were not in contact with targeted plants by their rhizomes system since the height of the their stem did not substantially varied following treatment (see FIG. 3).

No new growth was observed around the treated area, showing that the rhizomes system was eliminated in targeted treated plants and regeneration of stems was not observed, confirming the efficacy of the treatment.

Pressure injection of the saline solution showed a better efficacy in eliminating the plants since injecting the saline solution in the ground without pressure allowed to eliminate treated stems but did not totally eliminate the ability of plants to regenerate, as noted few weeks after treatment. Pressure injection allows a better distribution of the saline solution around the rhizomes and maximizes the effect of the treatment.

### Example II

### Analysis of Treatment of Japanese Knotweeds after Injection of a Saline Solution in the Ground

Another experimental protocol was conceived to measure the efficacy of a saline injection in the ground proximal to a Japanese knotweed plant to eliminate rhizomes of the plant. Testing site was selected around Montreal region, Canada.

In the delimited sites, height, number of leaves and branches of Japanese knotweed stems were measured.

Plastic markers were attached to each targeted stems before testing so that results could be analyzed qualitatively and quantitatively.

A saline solution of 12% NaCl was injected to a deepness of 30 cm proximal to the stem of the Japanese knotweeds identified by the markers. Efficacy of the injection was observed and measured (variation in stem survival and growth) compared with measurement and observation noted before treatments.

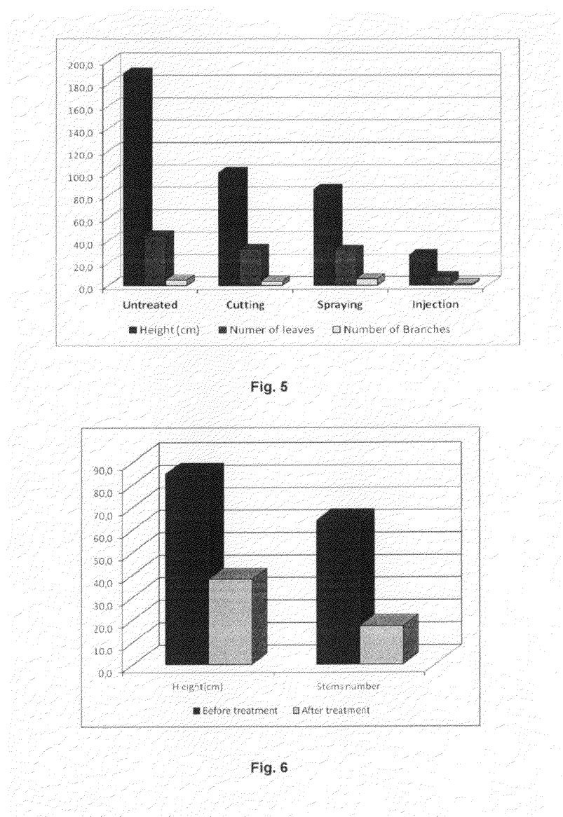

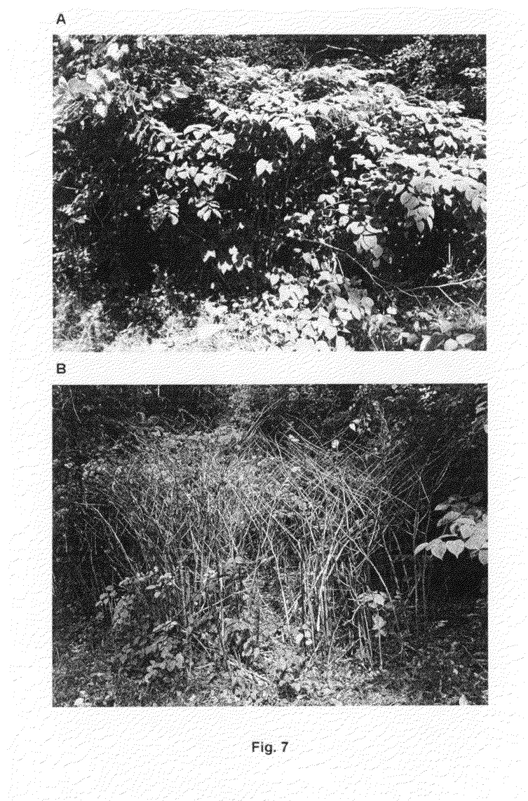

A first treatment was done in July of 2011 and another one at the end of august 2011 and results of 2012 demonstrate that almost all treated Japanese knotweed stems were eliminated. Precisely, mortality rate of 81.3% after one treatment and 97.8% after a second treatment were observed from the testing site (FIGS. 4 and 7).

In July of 2012, 11 months post treatment, treated plants show only little regeneration from rhizomes (FIG. 4). A small number of new shoots were observed even one year after the treatment.

### Example III

### Comparative Treatments on Japanese Knotweeds Including the Injection of a Saline Solution in the Ground

An experimental protocol was conceived to compare the efficacy of different control method including a saline injection in the ground proximal to a Japanese knotweed plant to eliminate rhizomes of the plant. Testing site was selected in a large colony with a size 1750 m² located in Montreal region, Canada.

On the same colony of Japanese knotweed, different methods to control the plant and to compare with the efficacy of a saline injection in the ground.

In the delimited sites, height, number of leaves and branches of Japanese knotweed stems were measured.

Plastic markers were attached to each targeted stems before testing so that results could be analyzed qualitatively and quantitatively.

For one of the treatment, a saline solution of 12% NaCl was injected to a deepness of 30 cm proximal to the stem of the Japanese knotweeds identified by the markers. Efficacy of the injection was observed and measured (variation in stem survival and growth) compared with measurement and observation noted before treatments (FIG. 5).

The other two comparative treatments consisted in cutting the stems near the ground and spraying a saline solution of 12% NaCl on the plants.

Testing was done in July of 2012 and results demonstrate that most treated Japanese knotweed stems were eliminated by the injection treatment compare to the other method. Precisely, mortality rate of 64.0% was observed from testing site with the injection method (see FIG. 5).

For the other two methods, cutting and spraying, no mortality of the stems was observed even if a reduction of height and number of leaves and branches was observed (FIG. 5).

### Example IV

### Treatment of Giant Hogweed by Injecting a Saline Solution in the Ground

Giant hogweed is native from Asia and has been introduced into Europe and North America. It is characterized by its size and may grow to 4.5 to 6 meters in height. It is most common along roadsides, vacant lots, streams and rivers, and can be considered an invasive weed. It forms a dense canopy, out-competing native riparian species and results in an increase in soil erosion along the stream banks where it occurs. Giant hogweed exudes a clear watery sap that sensitizes the skin to ultraviolet radiation which can result in severe burns.

Considering the size and the important root system of the plant, injecting saline solution in the ground represented an interesting control solution.

An experimental protocol was conceived to measure the efficacy of a saline injection in the ground proximal to a Giant hogweed plant to eliminate the root system of the plant. Testing site was selected around Montreal region, Canada.

In the delimited site, height and number of stems of Giant hogweed stems were measured.

Plastic markers were attached to each targeted stems before testing so that results could be analyzed qualitatively and quantitatively.

A saline solution of 12% NaCl was injected to a deepness of 30 cm proximal to the stem of the Giant hogweed identified by the markers. Efficacy of the injection was observed and measured (variation in stem survival and growth) compared with measurement and observation noted before treatments.

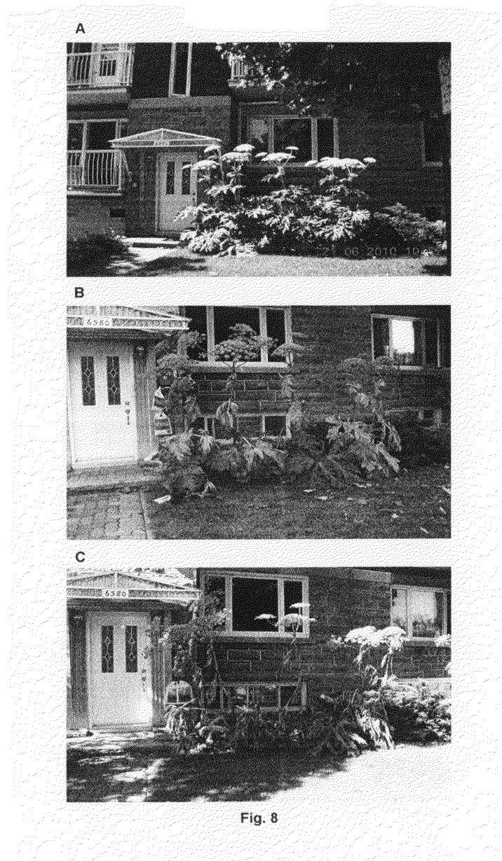

Testing was done in July of 2011 and results demonstrate that most treated Giant hogweed stems were eliminated. Precisely, a mortality rate of 73.4% was observed from the testing site (see FIG. 8).

The injection method induced a reduction of height and number of stems on the surviving stems (see FIG. 6).

While the invention has been described in connection with specific embodiments thereof, it will be understood that it is capable of further modifications and this application is intended to cover any variations, uses, or adaptations of the invention, and including such departures from the present disclosure as come within known or customary practice within the art to which the invention pertains and as may be applied to the essential features hereinbefore set forth, and as follows in the scope of the appended claims.

What is claimed is:

1. A method of controlling spread of a noxious weed plant comprising the step of injecting a non-toxic solution in the ground proximate to the stem of the noxious weed plant.

2. The method of claim 1, wherein the injection is a pressure injection.

3. The method of claim 1, wherein the non-toxic solution is injected at a pressure between 20 psi and 350 psi.

4. The method of claim 1, wherein the non-toxic solution is injected to a deepness of at least 30 cm.

5. The method of claim 4, wherein the non-toxic solution is injected to a deepness of at least 50 cm.

6. The method of claim 1, wherein 100 ml to 5 l of the non-toxic solution is injected.

7. The method of claim 1, wherein the non-toxic solution is a saline solution.

8. The method of claim 7, wherein the salt solution comprises a salt selected from the group consisting of aluminum chloride, ammonium phosphate monobasic, calcium chloride dihydrate, calcium chloride hexahydrate, calcium chloride anhydrous, calcium hypochlorite, calcium nitrate tetrahydrate, decansulphonic sodium acid salt, ethylene diamine tetraacetic acid disodium (EDTA); ethylene diamine tetraacetic acid tetrasodium (EDTA), ferric chloride hexahydrate, ferric chloride, ferric nitrate nonahydrate, ferrous chloride tetrahydrate, hepes sodium salt, iodine chloride, lithium chloride, magnesium chloride hexahydrate, magnesium nitrate, manganese chloride, 1-pentanesulphonic acid sodium salt, potassium chloride, potassium nitrate, potassium nitrite, sodium acetate anhydrous; sodium acetate trihydrate, sodium azide, sodium β-glycerophosphate, sodium benzoate, sodium bicarbonate, sodium bisulphite, sodium borate decahydrate, sodium borohydride, sodium bromide, sodium carbonate anhydrous, sodium carbonate decahydrous, sodium carbonate monohydrous, sodium chloride, sodium chlorite, sodium iodide, sodium nitrate, sodium nitrite, sodium silicate, sodium sulfate, sodium sulfite, sodium tripolyphosphate, sorbic acid, zinc chloride and zinc nitrate hexahydrate.

9. The method of claim 8, wherein the salt is NaCl.

10. The method of claim 9, wherein the non-toxic solution is a saline solution consisting of 8% to 20% weight to volume of NaCl.

11. (canceled)

12. The method of claim 11, wherein the saline solution consist of 12% weight to volume of NaCl.

13. The method of claim 1, wherein the non-toxic solution is Adios Ambros®.

14. The method of claim 7, wherein the saline solution further comprises at least one adjuvant.

15. The method of claim 1, wherein the noxious weed plant is a knotweed, a dandelion, a burdock, a buckthorn, a giant hogweed, an european swallow-wort or a cow parsley.

16. (canceled)

17. The method of claim 1, wherein injecting the non-toxic solution in the ground eliminates the rhizomes or the taproot of the noxious weed plant.

18. An injectable non-toxic solution for controlling spread of a noxious weed plant, said injectable non-toxic solution eliminating the rhizomes or the taproot of the noxious weed plant.

19. The injectable non-toxic solution of claim 18, wherein the injectable non-toxic solution is a saline solution.

20. The injectable non-toxic solution of claim 19, wherein the saline solution comprises a salt selected from the group consisting of aluminum chloride, ammonium phosphate monobasic, calcium chloride dihydrate, calcium chloride hexahydrate, calcium chloride anhydrous, calcium hypochlorite, calcium nitrate tetrahydrate, decansulphonic sodium acid salt, ethylene diamine tetraacetic acid disodium (EDTA); ethylene diamine tetraacetic acid tetrasodium (EDTA), ferric chloride hexahydrate, ferric chloride, ferric nitrate nonahydrate, ferrous chloride tetrahydrate, hepes sodium salt, iodine chloride, lithium chloride, magnesium chloride hexahydrate, magnesium nitrate, manganese chloride, 1-pentanesulphonic acid sodium salt, potassium chloride, potassium nitrate, potassium nitrite, sodium acetate anhydrous; sodium acetate trihydrate, sodium azide, sodium β-glycerophosphate, sodium benzoate, sodium bicarbonate, sodium bisulphite, sodium borate decahydrate, sodium borohydride, sodium bromide, sodium carbonate anhydrous, sodium carbonate decahydrous, sodium carbonate monohydrous, sodium chloride, sodium chlorite, sodium iodide, sodium nitrate, sodium nitrite, sodium silicate, sodium sulfate, sodium sulfite, sodium tripolyphosphate, sorbic acid, zinc chloride and zinc nitrate hexahydrate.

21. The injectable non-toxic solution of claim 20, wherein the salt is NaCl.

22. The injectable non-toxic solution of claim 21, wherein the non-toxic solution is a saline solution consisting of 8% to 20% weight to volume of NaCl.

23. (canceled)

24. The injectable non-toxic solution of claim 23, wherein the saline solution consist of 12% weight to volume of NaCl.

25. The injectable non-toxic solution of claim 19, wherein the non-toxic solution is Adios Ambros®.

26. The injectable non-toxic solution of claim 19, further comprising at least one adjuvant.

27. The injectable non-toxic solution of claim 19, wherein the noxious weed plant is a knotweed, a dandelion, a burdock, a buckthorn, a giant hogweed, an european swallow-wort or a cow parsley.

28. (canceled)
